(19) United States
(12) Patent Application Publication
(10) Pub. No.: US 2015/0112884 A1
(43) Pub. Date: Apr. 23, 2015

(54) Identifying Genetic Relatives Without Compromising Privacy

(71) Applicant: The Regents of the University of California, Oakland, CA (US)

(72) Inventors: Rafail Ostrovsky, Los Angeles, CA (US); Amit Sahai, Los Angeles, CA (US); Eleazar Eskin, Los Angeles, CA (US)

(21) Appl. No.: 14/520,273

(22) Filed: Oct. 21, 2014

Related U.S. Application Data
(60) Provisional application No. 61/894,363, filed on Oct. 22, 2013.

(51) Int. Cl. G06Q 50/26; G06Q 10/00

(52) U.S. Cl. CPC G06Q 50/265; G06Q 10/00
USPC 705/325

(57) ABSTRACT

Aspects of the invention include determining relatedness between genomes without compromising privacy. In one aspect, secure genome sketches of genomes can be made publicly available without compromising privacy. These are compared to privately held (unsecured) genome sketches to determine relatedness.

### CROSS-REFERENCE TO RELATED APPLICATION(S)

This application claims priority under 35 U.S.C. §119(e) to U.S. Provisional Patent Application Ser. No. 61/894,363, “Identifying Genetic Relatives Without Compromising Privacy,” filed Oct. 22, 2013. The subject matter of all of the foregoing is incorporated herein by reference in their entirety.

### GOVERNMENT RIGHTS LEGEND

This invention was made with Government support under Grant No. IIS-1065276, awarded by the National Science Foundation. The Government has certain rights in this invention.

### BACKGROUND OF THE INVENTION

1. Field of the Invention

This invention relates generally to identifying relatedness between genomes.

2. Description of the Related Art

Part I.

The field of human genetics has undergone a revolution within the past ten years with the advent of high-throughput genomic technologies, which can measure human genetic variation at ever-decreasing costs [Gunderson et al., 2005, Matsuzaki et al., 2004, Wheeler et al., 2008]. The development of these technologies were driven by the goal to perform genome-wide association studies (GWAS), where genetic variation information is collected from hundreds of thousands of individuals and correlated with disease status [Risch and Merikangas, 1996, Manolio et al., 2008, Hardy and Singleton, 2009]. These studies have linked hundreds of new genes to dozens of diseases [Hindorff et al., 2009]. While GWAS has been the most visible application of high-throughput genotyping technologies, other areas have been revolutionized as well. For example, these technologies have allowed researchers to ask fundamental questions about human history [Liu et al., 2006, Tishkoff et al., 2009, Reich et al., 2009], to identify genetic relationships between individuals [Stankovich et al., 200 Pemberton et al., 2010, Kyriazopoulou-Panagiotopoulou et al., 2011] and to characterize an individual's ancestry [Royal et al., 2010]. Over the past few years, a personal genomics industry has been established that provides genetic sequencing, genotyping and analysis services directly to consumers [Genetics and Public Policy Center, 2011].

One service that is currently provided by several personal genomics companies is the identification of relatives. The idea behind this service is that individuals provide genetic samples which are genotyped and then stored in a database. Each of the samples is compared to the other samples and any pair of individuals that appears to be genetically related are then notified of a genetic match. Unfortunately, this application, and more broadly most applications of personal genomics technology, require that individuals release or share their genetic data with other individuals or organizations that they may not necessarily trust. Individual-level genetic data is extremely sensitive, as it is considered health information about an individual. Furthermore, since each individual's genetic makeup is unique, an individual can be identified even from only a small fraction of his or her genetic data.

The genetics community has already been shaken by privacy issues with the discovery by Homer and colleagues [Homer et al., 2008], showing that individuals can be identified within a pool of DNA based only on aggregate statistics about the pool (in this case the frequency of variants). This result surprised the genetics community and the National Institute of Health, which in an effort to make the results of NIH research available to the public, was publicly releasing variant frequency information on GWAS disease and healthy populations. Given an individual's DNA information, the observation of Homer et al. (2008) can be exploited to ascertain if the individual was part of any public GWAS studies, exposing the disease status of that individual. More recently, Gymrek and colleagues [Gymrek et al., 2013] showed that they can reveal the identity of individuals in genetic reference datasets by combining small amounts of data in the individuals such as their approximate age with publicly available genetic databases and other data available on the internet. Understandably, these observations changed the NIH policy overnight, was widely reported in the media [Nature News, 2011, Nature News, 2013] and initiated much research in the area [Sankararaman et al., 2009, Jacobs et al., 2009, McGuire, 2008, Kahn, 2011, Heeney et al., 2011, Knoppers et al., 2011]. While it is critically important to protect an individual's privacy, restrictions on sharing genetic data severely limit the promise of high-throughput genomic technologies for personal genomics and medicine [Wang, 2011].

Part II.

Detecting relatives from genetic data is one of the fundamental problems in genetics. As genotype-chip technologies reduce the cost of collecting genetic data for each individual, many personal genomic companies provide various services. One such service is the identification of relatives using genetic data. The underling idea of this service is to collect genotypes of different individuals and to store their data in a database. Then, the genotype for each pair of individuals is compared and any pair of individuals that appear to be genetically related are notified of a match.

Unfortunately, the current version of this service provided by all companies requires individuals to share their genetic data with a trusted company.

Homer et al. (2008) already raised many privacy issues by showing that we can detect the existence of an individual in a pool of individuals when the minor allele frequency is available. Thus, the disease status of any individual involved in a GWAS might be exposed to the public. Furthermore, Sankararaman et al. (2009) extended the work (Homer et al., 2008) and showed that with access to thousands of variant summary statistics is enough for detecting the existence of an individual in a pool.

Recently, He et al. (2013) have proposed a secure method for detecting the genetic relatives using genotype data. This method uses the ‘fuzzy’ encryption (Dodis et al., 2008; Ishai et al., 2011). The ‘fuzzy’ encryption is very similar to the traditional encryption and decryption protocols where each individual has a public key and a private key. Public key for each individual is accessible by all the other individuals and the private key for each individual is hidden from all the other individuals. In the traditional protocol, we use the same private key to decrypt the message that was used to encrypt the message in the first place. However, in the ‘fuzzy’ encryption the two keys should be only close but not necessarily the same. Thus, an individual can detect the genetic relatives by downloading the available public key for all other individuals and compare their public key with his private key. They show if two individuals are genetically related their secure method can detect them while not leaking any information. Moreover, this method is designed such that individuals who are not related to others will not obtain any information. A drawback of this approach is that it can only be applied to common variants.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1: The number of segment matches can be used to determine if individuals are related. We split the genomes of each individual into segments of length 300 SNPs and then compare the number of segments where the haplotypes match exactly between any two individuals. Related individuals have a much higher number of matches when compared to unrelated individuals.

FIG. 2: The number of common genome sketch elements between two individuals is close to their number of segment matches. We measure the difference between the number of common genome sketch elements and the number of segment matches. The differences are small compared to the distance between related and unrelated individuals.

FIG. 3: Overview of Genome Sketch Construction. A simple example of private relative identification consisting of three individuals with their genome split into four segments, each consisting of 6 SNPs. In this example, individuals are related if they share all but one segment and unrelated otherwise. The genome sketch is constructed using sketch elements of length 3 bits.

FIG. 4: Conversion of Genome Sketch Sets into Vectors. The genome sketch consisting of elements of length 3 bits can be converted into a vector representation of length 2³=8.

FIG. 5: Encoding of Genome Sketches into Secure Genome Sketches. The genome sketch for the three individuals is converted unto a secure genome sketch by adding a random codeword (matrix row) selected from an error correcting code. Instead of addition, the figure uses the exclusive OR operation for clarity. These secure genome sketches are then made public.

FIG. 6: Decoding of Secure Genome Sketches to Identify Relatives. An individual identifies relatives by obtaining the public secure genome sketch from other individuals and subtracts his or her own genome sketch and attempts to decode the result using the coding matrix. Instead of addition, the figure uses the exclusive OR operation for clarity. If the decoding is successful, the individuals are related. If the decoding is unsuccessful, the individuals are unrelated.

FIG. 7: Histogram of the number of different values per segment in population for unrelated individuals. We consider the 96 parents in the CEU trios and the 104 parents in the YRI trios. For each segment, we count the number of different values within a segment. The maximum possible is twice the number of individuals (192 in CEU and 208 in YRI) in the case which each individual has a different value on each chromosomes. The histograms show that the vast majority of segment values differ between unrelated individuals.

FIG. 8. In traditional encryption and decryption protocol, each individual generates two codes using the key generation process. The public key (Pk) is accessible by everyone, and the private key (Sk) should be kept secret. In order to send a secure message to a sender we will use the public key available by the sender to encode the message. Then, the receiver will use the secret key (private), which was generated for the sender with the public key in the key generation process, to decrypt the message as shown in panel (A). The Fuzzy extractor is similar to traditional encryption and decryption protocol with one major difference, that the private key to decrypt the encrypted message has to be close to the original private key, which was generated in key generation process, and not necessary the same key as shown in panel (B).

FIG. 9. There exists a clear separation between the related and unrelated individuals. We use the LWK population from the 1000 genomes data as the founder and we use the cut-off of 25 390 segments to distinguish the related and unrelated individuals.

FIG. 10. The histogram of the number of matched segments between different individuals in the simulated data. We used the set of unrelated individuals in the LWK population from the 1000 genomes data as the founder. Panel (A) indicates our method which uses the rare variants to detect the relativeness between the different individuals and panel (B) indicates the result of the method proposed by He et al. (2013). Thus, utilizing the rare variants, we can detect up to fifth-degree cousin as opposed to the third-degree cousin.

FIG. 11. The histogram of the number of matched segments between different individuals in the 1000 genomes data. We used the ASW and LWK populations. For each pair of individuals we count the number of segments that are exactly match. We can use a cut-off of 25 390 segments to distinguish between the related and unrelated individuals in this dataset.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Aspects of the invention include determining relatedness between genomes without compromising privacy. In one aspect, secure genome sketches of genomes can be made publicly available without compromising privacy. These are compared to privately held (unsecured) genome sketches to determine relatedness.

All references, issued patents and patent applications cited within this disclosure are hereby incorporated by reference in their entirety, for all purposes.

### Part I

In certain aspects, we present a technological solution to the natural tension between privacy and the application of personal genomics technologies by capitalizing on recent breakthroughs in cryptography. We describe a method that enables the identification of first order relatives from genetic information while keeping one's genetic data private which we demonstrate using several HapMap populations [Altshuler et al., 2010]. Our general approach can be extended to more distant genetic relationships as we discuss below.

One aspect of our method takes advantage of a new technology referred to as “fuzzy” encryption [Dodis et al., 2008]. This methodology is centered around the concept of a “secure genome sketch” (SGS) which is an encrypted version of an individual's genome and is released publicly. Because of the encryption, SGSs preserve privacy in the sense that they do not reveal information about an individual's genome. Informally, the main idea behind the SGS is that the SGS uses information from an individual's genome as the encryption “key” in the context of a “fuzzy” encryption scheme. Unlike traditional encryption schemes where the key required for decryption must be identical to the key used in encryption, in a fuzzy encryption scheme, the encryption key and decryption key must only be similar. Thus, other individuals can detect whether or not they are related to the individual by using information from their own genomes to try to decrypt the SGS. If two individuals are related, their genomes will be close enough so that the decryption attempt will allow them to identify that they are related.

Results

Relative Identification by Segment Matching

We demonstrate our methodology using two populations from the HapMap Phase 3 data which contain related individuals. We use the CEU (European) and YRI (African) populations which have different degrees of linkage disequilibrium to highlight the robustness of our approach. The CEU population consists of 165 individuals made up of 96 related pairs and 13,434 unrelated pairs. The YRI population is made up of 167 individuals and contains 104 related pairs and 13,757 unrelated pairs. The individuals are genotyped at 1,387,466 single nucleotide polymorphisms (SNPs) [Altshuler et al., 2010]. When the dataset was constructed, it was assumed that the remaining individuals were unrelated, but recent studies have identified many unannotated relationships [Pemberton et al., 2010]. We apply KING [Manichaikul et al., 2010], a method for predicting genetic relationships from whole genome datasets, to identify the unannotated genetic relationships and eliminate these pairs from consideration. This results in the elimination of 27 unrelated pairs from the CEU dataset and 12 unrelated pairs from the YRI dataset which is consistent with previous attempts to identify the unannotated relationships.

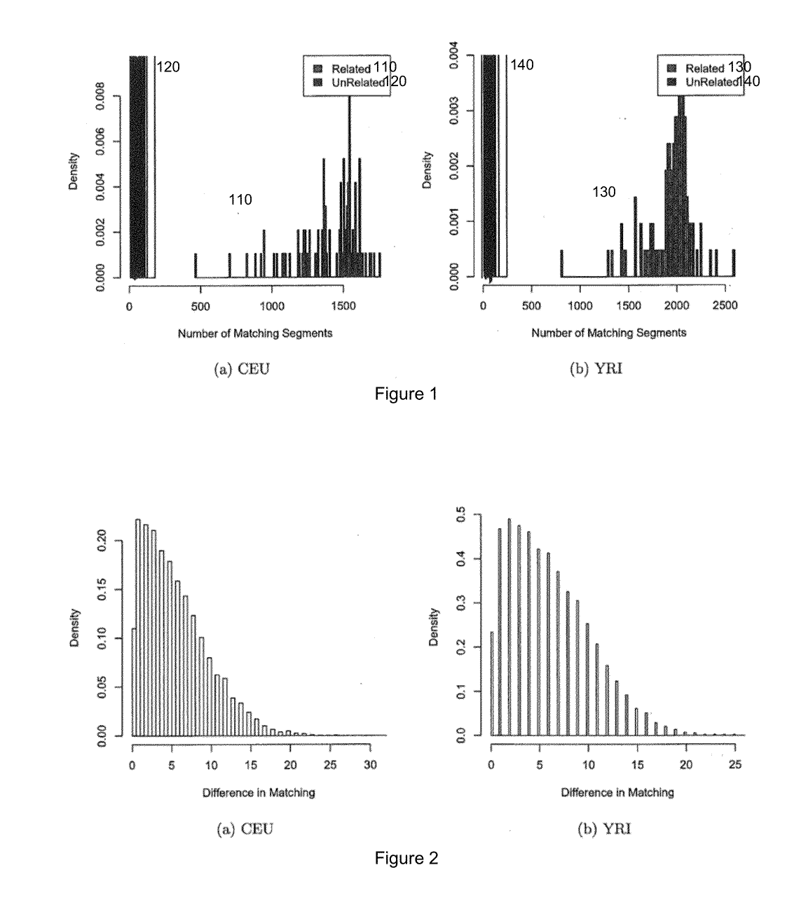

The standard approach to identifying whether or not a pair of individuals are closely related is to predict identity-by-descent (IBD) regions between the individuals and then use the amount of shared IBD regions to quantify the amount of genetic relatedness [Pemberton et al., 2010]. We propose a simple approximation to this scheme that we demonstrate is adequate for identifying close relatives and is amenable to the encryption methods proposed. We partition each individual's genome into segments, each consisting of a fixed number of markers. In our case, we split the individual's genomes into 4,625 segments, each consisting of 300 SNPs. We phase each individual's genotypes to obtain the haplotypes for each segment. We approximate the relatedness of two individuals by computing the number of segments where one of the haplotypes matches exactly and refer to this quantity as the number of “segment” matches between a pair of individuals. Below we will explain how we perform this comparison securely. FIG. 1 shows a histogram of the number of matches between related and unrelated pairs of individuals in the HapMap samples. The threshold of 400 separates the related individuals from unrelated individuals. We note that shared IBD regions between close relatives are typically longer than our segments, and would likely span several neighboring segments.

Genome Sketches

We define a “genome sketch” (GS) as a representation of an individual's segments that allows us to compute the number of segment matches between a pair of individuals without revealing the full genetic information of an individual. A GS is obtained by converting the values of the haplotypes for each segment, into a pair of 300-bit values where 0 represents the major allele and 1 represents the minor allele. Information on the segment number which is encoded as a 13 bit binary number is incorporated by adding the segment number to each 300-bit haplotype value. The resulting pair of 300-bit values are then converted into a pair of 24-bit strings using collision resistant hashing, where each value in the pair represents a haplotype at a segment. The set of 9,250 resulting 24-bit values for each individual compose an individual's genome sketch. We compare two individuals by computing how many of their 9,250 elements are common to both individuals. An common element is an indicator that in some segment of the genome, the two individuals have exactly the same haplotype.

Comparing genome sketches from two individuals by counting the number of overlaps (or computing the set distance—also known as the Jaccard similarity coefficient) closely estimates the number of segments where the two individuals have a shared haplotype. This estimate is a slight overestimate because of the possibility that two different 300-bit segment values are converted to the same 24-bit sketch element. FIG. 2 shows that for most pairs, the difference between the number of genome sketch overlaps and the segment overlaps is less than 10. This is much smaller than the difference between related and unrelated individuals (FIG. 1).

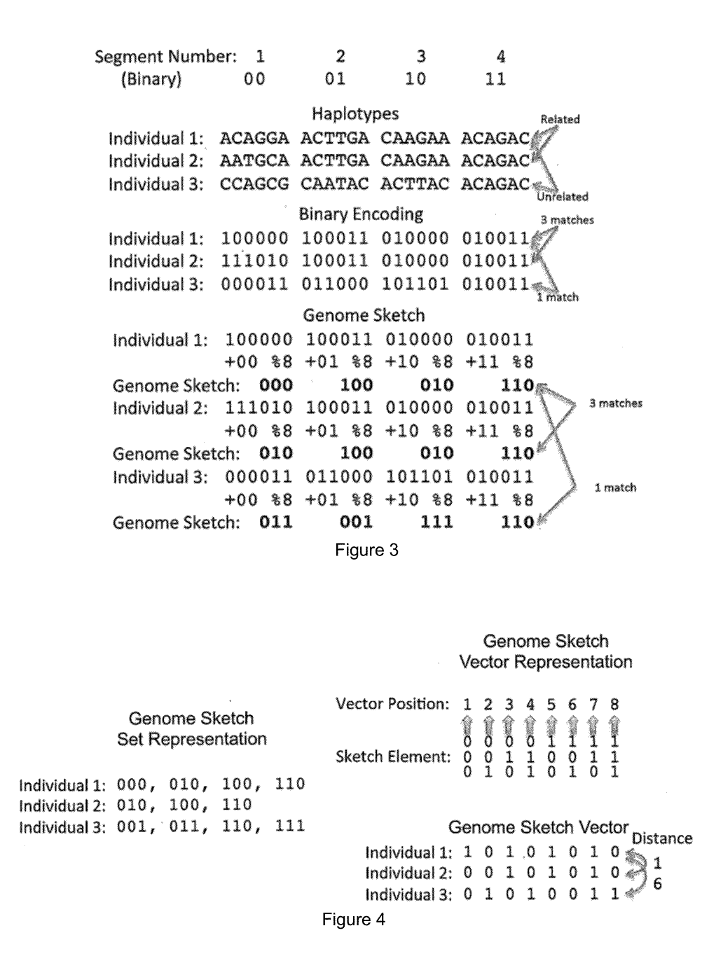

FIG. 3 shows a cartoon example of creating a genome sketch for three individuals. In this example, for simplicity, we assume that individuals each only have one chromosome consisting of 24 SNPs split into 4 segments of 6 SNPs. In this example, individuals 1 and 2 are related, while individual 3 is unrelated to the two other individuals. In our example, we assume that to be related, two individuals must share the exact haplotype at three out of the four segments. While this example is obviously much smaller in scale than the full genome, we can use it to illustrate our complete cryptographic scheme for relative identification.

In our example, a genome sketch is converted by summing the binary representation of the haplotype in each segment with the segment number and then hashing to a 3-bit value. For clarity of the example, instead of a hash function we simply take the last 3 digits of this sum as the genome sketch element (represented by “%8”). The genome sketch is the set of these values for each individual. Note that for individual 2, there was a collision in the hashing between the first and third segment which resulted in only three genome sketch elements.

A genome sketch can be either represented as a set or as a vector of size 2^{k} where k is the number of bits of each sketch value. FIG. 4 shows the conversion of the genome sketches for each individual into a binary vector of length 8. Each position in the vector corresponds to a potential sketch element and the vector has a 1 if the individual's genome sketch contains that element and 0 otherwise. The number of positions that match or distance between the genome sketch vectors of a pair of individuals is closely related to the number of matching segments.

A genome sketch has some advantageous properties in terms of privacy. If two individuals differ by even a single SNP within a segment, because of the way a segment value is converted to a sketch value (See Methods), the corresponding genome sketch values will completely differ. One approach to relative identification is to have individuals release their genome sketches publicly. Users can then compare their genome sketch to other genome sketches to identify which individuals they are related to. Unfortunately, this solution reveals private information. Each individual can obtain information about another individual's genome whenever there is an exact match. Since even unrelated individual's share some IBD regions, some genetic information will be compromised. In our example in FIG. 3, if individual 3 has access to the genome sketch of individual 2, individual 3 can infer that they have the same haplotype in the fourth segment because they share the genome sketch value “110”. Furthermore, an individual can use the genome sketches of publicly available genetic datasets such as those from the 1000 Genome project [Consortium, 2010] or HapMap [Altshuler et al., 2010] and obtain genetic information from any individual that shares IBD with any individual in the database.

Secure Genome Sketches

We address the privacy issue of genome sketches by using a new cryptographic construct called a “secure sketch.” A secure sketch is a construct which allows for the computation of set distance between two sketches only if their distance is within a certain threshold (see [Dodis et al., 2008] and references therein for a further discussion of secure sketches). The ideas underlying our encryption scheme are closely related to the theory of error-correcting codes (ECC) [Huffman and Pless, 2003]. We translate a genome sketch into a secure genome sketch using an error-correcting code matrix and use this matrix for identifying relationships.

In our approach, users will have access to their own genome sketches (GS) which they will keep private. Users will also create what we will call a “secure genome sketch” (SGS) using their GS as a starting point which they will make public. The way a user will determine whether they are not related to another individual is to obtain that individual's SGS and then attempt to use their own GS to check if they are related.

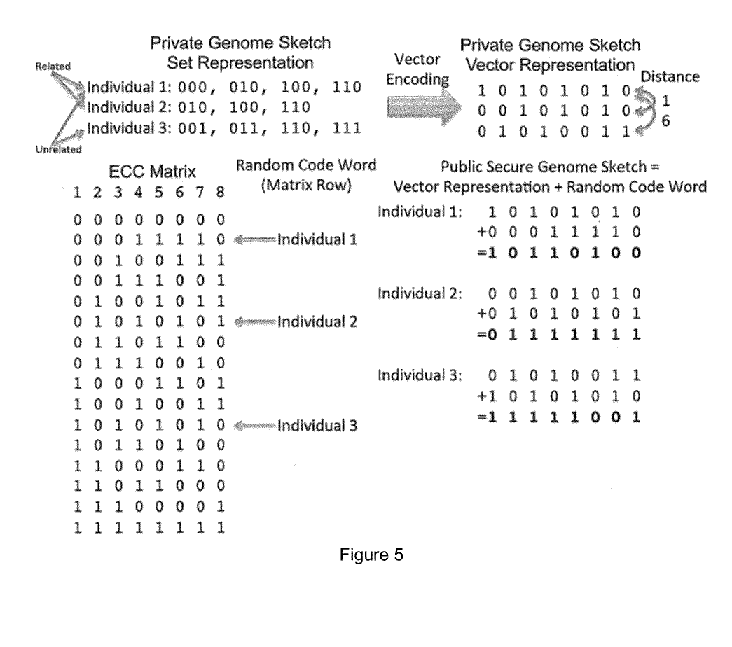

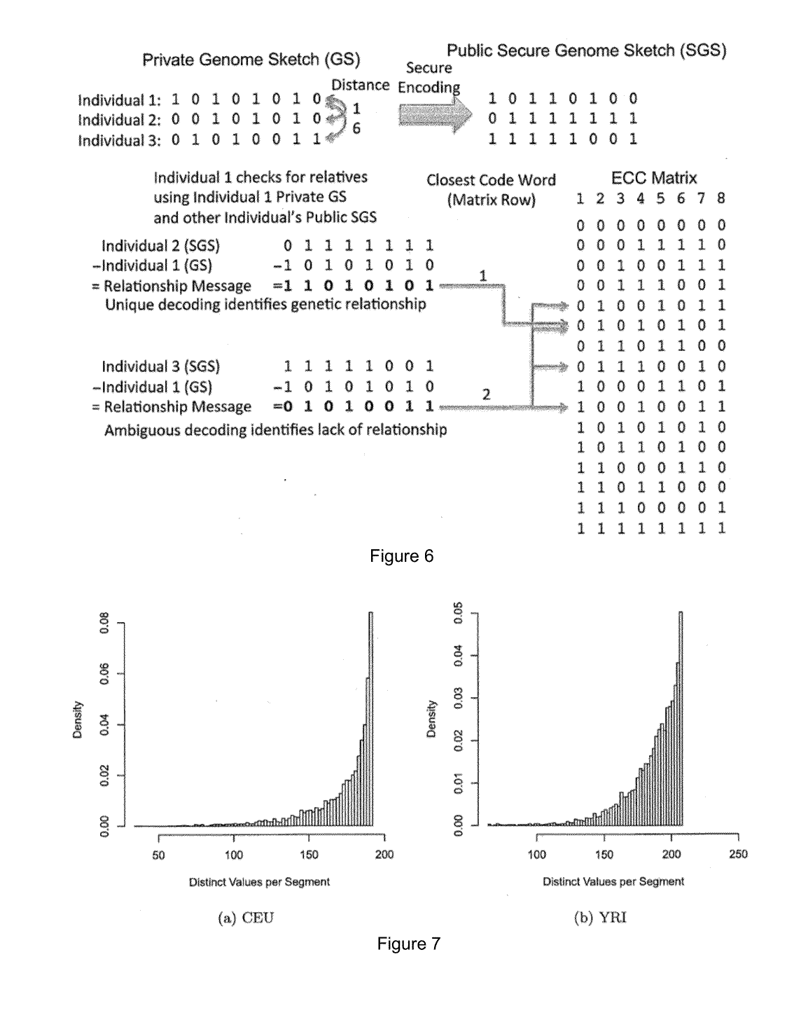

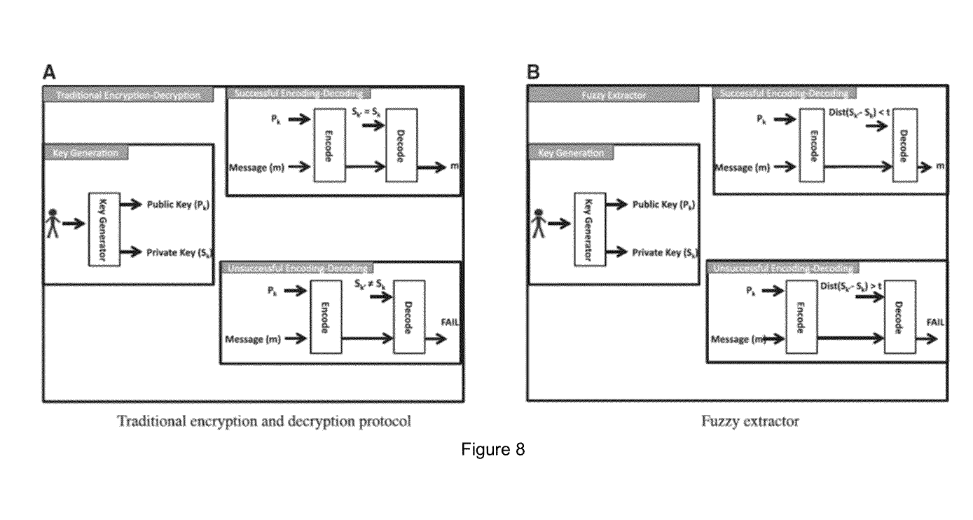

FIGS. 5 and 6 illustrate a simplified example of our system continuing the example from FIGS. 3 and 4. While this example is much smaller than the true genome, the basic ideas behind the approach are the same. We will later use a method called PinSketch [Dodis et al., 2008] which applies similar ideas, yet is able to scale to the size of the genome where sketches have 4,625 segments, each represented by a 24-bit vector, and individuals are related if they share 400 segments.

In our example, there are three individuals where the first two individuals are related and the third individual is unrelated. Genome sketches are generated with aid of an error-correcting code matrix that is the same width as the length of the genome sketch vector. FIG. 5 shows an example of an error-correcting code (ECC) matrix, which in this case is the famous Hamming Code (7,4) with a parity bit. Each row of the ECC matrix is referred to as a codeword. Error-correcting codes are widely used in wireless communications where the goal is to transmit signals accurately and be robust to errors. This code is designed to send a 4-bit message (the first 4-bits of the code highlighted in blue); the remaining four columns are designed in such a way that they allow for errors in the communications but still retain the ability for recovering the message. For example, if someone wanted to transmit the message “0010,” they would use the coding matrix to convert the message to the 8-bit codeword “00100111” and transmit the codeword. If in the transmission, there was an error in the 4th position that resulted in the received signal “00110111,” the receiver can still recover the correct message by using the matrix to “decode” the transmission by finding the row which most closely matches the signal. In this case, the only row of the matrix that matches the signal with one error is the correct row and this allows for the recovery of the message. On the other hand, if there were three errors in the signal that resulted in “10000110” that would mean that the signal could not be decoded since four rows would match with two errors.

To generate a genome sketch, an individual randomly selects a row of the matrix and sums the row with his or her genome sketch (FIG. 5). This resulting secure genome sketch is then made public. To then identify a relationship, an individual would obtain a public genome sketch from another individual and subtract their own genome sketch (FIG. 6) resulting in what is called a “relationship message”. They would then attempt to use the code matrix to decode the resulting relationship message. If the decoding is successful—that is, the result closely matches a row in the coding matrix—this implies that the individuals are related. If the decoding is unsuccessful, this implies that the individuals are unrelated. The intuition is that if the two individuals are related, then the difference between their genomes is small and what is decoded will be close to a matrix row or codeword.

In the example, individual 1 randomly selected the second matrix row, individual 2 randomly selected the sixth matrix row and individual 3 randomly selected the eleventh matrix row (FIG. 5). These choices were then summed to their genome sketches to make the public secure genome sketches. In our example, we are demonstrating the process of individual 1 to identify relatives. Individual 1 would obtain both public SGSs from individuals 2 and 3. Individual 1 then subtracts his or her own private genome sketch from each of these SGS and attempts to decode the result using the coding matrix. Instead of addition and subtraction, we use the exclusive OR operation for clarity of the figure. The exclusive OR results in a 0 when the two digits match and a 1 otherwise. Note that when attempting to decode the result from individual 2, the decoding is successful and identifies the sixth row as the closest match. This is exactly the row that individual 2 chose randomly when creating the SGS. The reason why this decoding is successful is that the difference between the GS of individual 1 and individual 2 is small enough that the error correcting code can still decode successfully. The fact that the decoding is successful allows individual 1 to know that individual 2 is a relative. When attempting to decode the result from individual 3, the decoding is unsuccessful and there are 4 rows which are equidistant from the result. This implies that the genome sketches of individual 1 and individual 2 are farther apart than the distance that the error correct can decode and thus the individuals are unrelated. The ability to successfully decode a vector is related to the distance between rows or codewords in the error correcting code. We utilize a code such that the distance is set so that only pairs of individuals which are within the relatedness threshold can successfully decode their SGSs.

In order to scale to the genome, we utilize a recently developed method, PinSketch [Dodis et al., 2008]. Computing the similarity of genome sketches involves comparing the overlap of sets of 24-bit vectors. This can be thought of as computing the Hamming distance between length 2²⁴-bit vectors, each representing the genome sketch of an individual where each position represents a specific 24-length vector, and the bit is 1 if the individual contains that genome sketch element and 0 otherwise. Typically, an individual will have 9,250 non-zero bits in each vector. Similarly, the error correcting code matrix will have width 2²⁴. The distance between words of the code matrix is 800, corresponding to the threshold of 400. A major advantage of the PinSketch method is that it provides an efficient algorithm for both encoding and decoding a genome sketch represented as a set.

Identification of Relatives in the HapMap data

We demonstrate our methodology by applying it to the HapMap data. In our simulation we assume that the 165 CEU and 167 YRI individuals all have access to their genetic information, yet do not know which other individuals are relatives. Each individual wants to identify any relatives without revealing their genetic information. Each individual generates a secure genome sketch using the phased 1,387,466 SNPs and makes these sketches public.

Then each individual obtains the set of secure sketches from all of the remaining individuals and applies PinSketch to compare their own genome to the secure sketch of each of the other 321 individuals. The total number of comparisons performed is 109,892. We omit performing the comparisons on the 27 ambiguous relationships in the CEU population and the 12 ambiguous relationships in the YRI population. 48 of the CEU individuals and 54 of the YRI individuals are children in trios and we correctly identify both of their parents. The parents each correctly identify a genetic relationship with their children. In no cases do we incorrectly predict a genetic relationship among individuals who are not related. When performing the comparisons, no genetic information was revealed to the other individuals.

Security of Secure Genome Sketches

A general question is—how secure are secure genome sketches? We refer to “security” in the cryptographic sense. This is equivalent to asking how difficult is it to reverse engineer a secure genome sketch to a genome sketch and similarly how difficult is it to reverse engineer a genome sketch into an actual genome? This question can be addressed in a very general way by considering the relative amount of information in the individual's genome sketch compared to the amount of information publicly released in an individual's secure genome sketch. The “amount of information” is quantified in terms of “entropy,” or the number of bits required to encode the information.

The amount of information released as part of an individual's secure genome sketch depends on the cryptographic scheme used to perform the encryption and is tied both to the entropy of the dataset and the “relatives” threshold that we must recognize. Each scheme defines an “entropy loss” that defines the amount of information released. In our approach, since we are using PinSketch, then entropy loss is t log(n+1) where t is twice the threshold and n is the number of possible sketch elements [Dodis et al., 2008]. In that case, the amount of entropy loss is 20,000, or on average slightly more than 2 bits per sketch element.

In our application, a genome sketch consists of 9,650 24-bit elements. The maximum amount of entropy contained in a genome sketch is then 231,600 bits. However, the actual number is smaller since not all 24-bit values are equally likely to be present in an individual, and the values that do occur in one segment are not necessarily independent of the values in other segments. In order for our approach to be secure, the amount of entropy in the genome sketch must be much higher than the amount of entropy loss of PinSketch. If we were able to obtain a complete distribution for haplotypes for the human population in each segment, we could directly measure the amount of entropy in the genome sketch. Unfortunately, since we only have access to a finite number of individuals, it is impossible to accurately measure this entropy. However, the amount of entropy is likely very high because in our dataset almost every unrelated individual has unique values for most segments, as shown in FIG. 7. Therefore, we expect the amount of entropy in the genome sketch to far exceed the amount of entropy loss in our approach, thus providing a significant amount of security. We note that the entropy lass scales linearly with the threshold which implies that more entropy loss is required when attempting to discover more distant relationships.

Discussion

We have proposed a new approach for addressing the inherent tension between privacy and data sharing in personal genomics which leverages recent developments in cryptography and demonstrate how these developments can be used to identify genetic relationships while preserving privacy. The key idea of our approach is that each individual releases specially encrypted information about their genome which allows for other individuals to identify if they are related, but the information does not reveal any information about the individual's genome in the event they are not.

We demonstrated our approach using two populations from the HapMap with very different linkage disequilibrium structures and known genetic relationships. Our current implementation is tuned to identify first-order genetic relationships. However, we can arbitrarily define the threshold to identify more distant relationships such as first or second cousins. We note that there is a tradeoff between our ability to detect more distant relationships and the “entropy loss” which determines how secure our approach is in terms of privacy. Adequately determining exactly what types of relationships can be identified while preserving privacy can only be answered by measuring the entropy in large reference datasets such as those currently being collected in the community.

The recent development of sequencing technology allows for the cost effective collection of rare variants from an individual. This technology has implications for relative identification because it allows for utilizing a rare variants to identify segments that are identical by descent. However, rare variants complicate the application of this technique because many of them are unlikely to be discovered in advance which will require novel methods for constructing genome sketches.

In our approach, if two individuals are unrelated, they cannot obtain any information about each other's genome. However, our current implementation can be utilized to reveal exactly the shared genomic regions between a pair of related individuals. The reason is that when a secure genome sketch is successfully decoded, the number of errors between the difference of the secure genome sketch and an individual's genome sketch and the error correcting codeword is obtained. This number of errors is corresponds to the number of segments which differ between the individuals.

An individual can then perform the decoding leaving out one element of their genome sketch each time and observe when the number of errors increases. Each time the number of errors increases, the individual can infer that the corresponding haplotype is present at the corresponding segment of the individual. Thus an individual can obtain information about which parts of the genome are identical by descent with a relative. We can remedy this problem by using a secure computation approach (for example see [Ishai et al., 2011] and the references therein) and this is a direction for future work.

Methods

HapMap Phase 3 Data

We used the genotypes from release 28 of the HapMap Phase 3 data. Since we also use the HapMap data as a reference for performing phasing, we phase and impute missing data in each population by using BEAGLE [Browning and Browning, 2009] imputation using the remaining populations as the reference sets. This avoids any bias from inclusion of a sample in the reference datasets.

Genome Sketches

Haplotypes for each of 4,625 segments consist of a pair of 300-bit values which encode the values of the SNP for the haplotype and a binary representation of the segment number, requiring 13 bits. For each haplotype in a segment, the sum of the 300-bit value and the 13-bit segment number is computed. This number is added to a fixed 100-bit value called a salt. The salt is a random 100-bit number that is public and used for the encoding of all individuals. This resulting 300-bit value is then hashed using the SHA-256 Secure Hash Algorithm [NIST, 2008] and the first 24 bits from the hash are saved to comprise the genome sketch corresponding to the haplotype. Note that because of the SHA-256 hashing, even two haplotypes in the same region that differ by only one SNP will be hashed to completely different values, thereby creating genome sketch elements which are completely different.

Secure Genome Sketches

In our construction, we use PinSketch [Dodis et al., 2008] to convert our genome sketches into secure genome sketches (SGS) using a threshold of 400. Individuals can then make public their SGS and use PinSketch to compare their genome sketch to another individual's SGS to determine if the genome sketches are within a distance of the threshold that identifies a genetic relationship. However, if the distance is greater than the threshold, no information about the genome is revealed.

SGSs utilize the approach described in FIG. 5 and FIG. 6. An individual's set of sketch elements can be represented as a bit vector of length 2²⁴ with approximately 9, 250 elements with value 1 and the remaining with value 0. PinSketch does not explicitly represent an individual's genome sketch as this vector, but instead represents an individual by keeping track of which are the non-zero values of the bit vector that correspond to the set of sketch elements. Similarly, PinSketch does not explicitly represent the coding matrix of width 2²⁴. The main insight of PinSketch is to take advantage of the fact that even though the space of possible genome sketches is huge (2²^{²⁴}), each individual's genome sketch will only contain 9, 250 non-zero elements. PinSketch is able to take advantage of this sparsity to efficiently perform encoding and decoding.

### REFERENCES

[Altshuler et al., 2010] Altshuler, D. M., Gibbs, R. A., Peltonen, L., Altshuler, D. M., Gibbs, R. A., Peltonen, L., Dermitzakis, E., Schaffner, S. F., Yu, F., Peltonen, L., et al., 2010. Integrating common and rare genetic variation in diverse human populations. Nature, 467(7311):52-8.
[Browning and Browning, 2009] Browning, B. L. and Browning, S. R., 2009. A unified approach to genotype imputation and haplotype-phase inference for large data sets of trios and unrelated individuals. Am J Hum Genet, 84(2):210-23.
[Consortium, 2010] Consortium, G. P., 2010. A map of human genome variation from population-scale sequencing. Nature, 467(7319):1061-73.
[Dodis et al., 2008] Dodis, Y., Ostrovsky, R., Reyzin, L., and Smith, A., 2008. Fuzzy extractors: How to generate strong keys from biometrics and other noisy data. SIAM JOURNAL ON COMPUTING, 38(1):97-139.
[Genetics and Public Policy Center, 2011] Genetics and Public Policy Center, 2011. Alphabetized Genetic Testing Companies. http://www.dnapolicy.org/resources/AlphabetizedDTCGeneticTestingCompanies.pdf. [Online; accessed 21 Sep. 2011].
[Gunderson et al., 2005] Gunderson, K., Steemers, F., Lee, G., Mendoza, L., and Chee, M., 2005. A genome-wide scalable SNP genotyping assay using microarray technology. Nat Gen, 37(5):549-554.
[Gymrek et al., 2013] Gymrek, M., McGuire, A. L., Golan, D., Halperin, E., and Erlich, Y., 2013. Identifying personal genomes by surname inference. Science, 339(6117):321-324.
[Hardy and Singleton, 2009] Hardy, J. and Singleton, A., 2009. Genomewide association studies and human disease. New Eng J Med, 360(17):1759-1768.
[Heeney et al., 2011] Heeney, C., Hawkins, N., De Vries, J., Boddington, P., and Kaye, J., 2011. Assessing the privacy risks of data sharing in genomics. Public Health Genomics, 14(1):17-25.
[Hindorff et al., 2009] Hindorff, L., Sethupathy, P., Junkins, H., Ramos, E., Mehta, J., Collins, F., and Manolio, T., 2009. Potential etiologic and functional implications of genome-wide association loci for human diseases and traits. Proc Natl Acad Sci, 106(23):9362.
[Homer et al., 2008] Homer, N., Szelinger, S., Redman, M., Duggan, D., Tembe, W., Muehling, J., Pearson, J., Stephan, D., Nelson, S., and Craig, D., et al., 2008. Resolving individuals contributing trace amounts of DNA to highly complex mixtures using high-density SNP genotyping microarrays. PLoS Genet, 4(8):e1000167.
[Huffman and Pless, 2003] Huffman, W. and Pless, V., 2003. Fundamentals of error-correcting codes. Cambridge university press.
[Ishai et al., 2011] Ishai, Y., Kushilevitz, E., Ostrovsky, R., Prabhakaran, M., and Sahai, A., 2011. Efficient non-interactive secure computation. In Paterson, K., editor, Advances in Cryptology EUROCRYPT 2011, volume 6632 of Lecture Notes in Computer Science, pages 406-425. Springer Berlin/Heidelberg.
[Jacobs et al., 2009] Jacobs, K., Yeager, M., Wacholder, S., Craig, D., Kraft, P., Hunter, D., Paschal, J., Manolio, T., Tucker, M., Hoover, R., et al., 2009. A new statistic and its power to infer membership in a genome-wide association study using genotype frequencies. Nat Genet, 41(11):1253-1257.
[Kahn, 2011] Kahn, S., 2011. On the future of genomic data. Science, 331(6018):728-729.
[Knoppers et al., 2011] Knoppers, B., Harris, J., Tasse, A., Budin-Ljosne, I., Kaye, J., Deschenes, M., and Man, H., 2011. Towards a data sharing code of conduct for international genomic research. Genome Med, 3(7):46.
[Kyriazopoulou-Panagiotopoulou et al., 2011] Kyriazopoulou-Panagiotopoulou, S., Kashef Haghighi, D., Aerni, S. J., Sundquist, A., Bercovici, S., and Batzoglou, S., 2011. Reconstruction of genealogical relationships with applications to Phase III of HapMap. Bioinformatics, 27(13):i333-41.
[Liu et al., 2006] Liu, H., Prugnolle, F., Manica, A., and Balloux, F., 2006. A geographically explicit genetic model of worldwide human-settlement history. Am J Hum Genet, 79(2):230-7.
[Manichaikul et al., 2010] Manichaikul, A., Mychaleckyj, J. C., Rich, S. S., Daly, K., Sale, M., and Chen, W.-M. M., 2010. Robust relationship inference in genome-wide association studies. Bioinformatics, 26(22):2867-73.
[Manolio et al., 2008] Manolio, T., Brooks, L., and Collins, F., 2008. A HapMap harvest of insights into the genetics of common disease. J Clin Invest, 118(5):1590.
[Matsuzaki et al., 2004] Matsuzaki, H., Dong, S., Loi, H., Di, X., Liu, G., Hubbell, E., Law, J., Berntsen, T., Chadha, M., Hui, H., et al., 2004. Genotyping over 100,000 SNPs on a pair of oligonucleotide arrays. Nat Methods, 1(2):109-111.
[McGuire, 2008] McGuire, A., 2008. Identifiability of DNA data: the need for consistent federal policy. Am J Bioeth, 8(10):75-76.
[Nature News, 2011] Nature News, 2011. DNA databases shut after identities compromised. Nature, 455(13).
[Nature News, 2013] Nature News, 2013. Genetic privacy. Nature, 493(7433):451.
[NIST, 2008] NIST, 2008. FIPS, PUB 180-3: Secure hash signature standard. http://csrc.nist.gov/publications/fips/fips180-3/fips180-3 final.pdf,
[Pemberton et al., 2010] Pemberton, T. J., Wang, C., Li, J. Z., and Rosenberg, N. A., 2010. Inference of unexpected genetic relatedness among individuals in HapMap Phase III. Am J Hum Genet, 87(4):457-64.
[Reich et al., 2009] Reich, D., Thangaraj, K., Patterson, N., Price, A. L., and Singh, L., 2009. Reconstructing Indian population history. Nature, 461(7263):489-94.
[Risch and Merikangas, 1996] Risch, N. and Merikangas, K., 1996. The future of genetic studies of complex human diseases. Science, 273(5281):1516.
[Royal et al., 2010] Royal, C. D., Novembre, J., Fullerton, S. M., Goldstein, D. B., Long, J. C., Bamshad, M. J., and Clark, A. G., 2010. Inferring genetic ancestry: opportunities, challenges, and implications. Am J Hum Genet, 86(5):661-73.
[Sankararaman et al., 2009] Sankararaman, S., Obozinski, G., Jordan, M., and Halperin, E., 2009. Genomic privacy and limits of individual detection in a pool. Nat Gen, 41(9):965-967.
[Stankovich et al., 2005] Stankovich, J., Bahlo, M., Rubio, J. P., Wilkinson, C. R., Thomson, R., Banks, A., Ring, M., Foote, S. J., and Speed, T. P., 2005. Identifying nineteenth century genealogical links from genotypes. Hum Genet, 117(2-3):188-99.
[Tishkoff et al., 2009] Tishkoff, S. A., Reed, F. A., Friedlaender, F. R., Ehret, C., Ranciaro, A., Froment, A., Hirbo, J. B., Awomoyi, A. A., Bodo, J.-M. M., Doumbo, O., et al., 2009. The genetic structure and history of Africans and African Americans. Science, 324(5930):1035-44.
[Wang, 2011] Wang, J., 2011. Genome-sequencing anniversary. personal genomes: for one and for all. Science, 331(6018):690.
[Wheeler et al., 2008] Wheeler, D. A., Srinivasan, M., Egholm, M., Shen, Y., Chen, L., McGuire, A., He, W., Chen, Y.-J. J., Makhijani, V., Roth, G. T., et al., 2008. The complete genome of an individual by massively parallel dna sequencing. Nature, 452(7189):872-6.

### Part II

In other aspects, we propose a novel encoding mechanism that convert each individual's haplotypes to a set of integer values such that the comparison between two sets approximate the genetic comparison between the two individuals where each individual has access only to its own variants list. The main innovations of our approach compared to He et al. (2013) is that we use a novel encoding which allows for us to utilize all variants in an individual's genome. This is challenging because many of the variants have not yet been discovered. In addition, our cryptographic scheme uses list decoding which has some advantages to other approaches for fuzzy encryption.

We use both simulated and real data to show the utility of our method. We generated series of family relationships using the 1000 genomes data as the founder of the population. Then, we randomly generated offsprings for different generations. With the simulated data, we show that our secure protocol could detect up to fifth degree cousins. However, the previous method (He et al., 2013) can only detect up to third degree cousins. Furthermore, we use Luhya in Webuye (LWK) population from the 1000 genomes data (1000 Genomes Project Consortium, 2010, 2012) that contains cryptic relationships to show that method could detect these cryptic individuals.

Methods

2.1 Overview

Our method uses the ‘fuzzy’ encryption, which is a new method in the field of cryptography (Dodis et al., 2008; Ishai et al., 2011). The ‘fuzzy’ encryption is similar to the traditional encryption and decryption protocols where each individual has a public key and a private key. The public key for each individual is accessible by all other individuals and the private key for each individual is hidden from all other individuals. In a traditional protocol to decrypt the message we use the same private key that was used to encrypt the message in the first place as shown in 8A. However, in ‘fuzzy’ encryption, decryption is possible only if the Hamming distance between the two keys is less than a predefined threshold ‘t’ as shown in 8B. The ‘fuzzy’ decryption terminates successfully if the Hamming distance between the keys is 5‘t’ and it fails otherwise. Mostly, the keys used in ‘fuzzy’ encryption are in form of extremely long vectors which are sparse and the sparsity allows us to compute the Hamming distance efficiently using ‘fuzzy’ encryption.

Fuzzy extractors can be used to implement secure comparison of sets of a fixed size (number of elements in a set) which is the basis of our approach to private relative identification. The secure comparison of sets works as follows. Each individual has a set of elements which is private to the individual. Using the cryptographic protocol based on fuzzy extractors, each individual is able to identify which other individuals have a set with at least ‘t’ elements in common. The way the protocol works is that each individual releases some public information referred to as a ‘secure sketch’ and then individuals compare their sets against the sketches of others. The individual can recognize if the sets of the two individuals contain at least ‘t’ common elements.

The way secure set comparison is implemented using fuzzy extractors is that the private keys that are generated encode the membership of each element of the set. We consider all sets contain k elements, each of which is binary vectors of length m, then there are a total of 2^{m} possible elements. The private keys are binary vectors of length 2^{m} with k ‘1’s encoding which element exists in an individual's set. We use fuzzy extractors to generate public keys for these private keys where the threshold for decryption is 2k−t: Any pair of private keys which have Hamming distance 5\check{o}2k−t [symbol] are correspond to sets that have at least ‘t’ elements in common. Any pair of private keys that have Hamming distance of 4\check{o}2k−t [symbol] will have 5‘t’ elements in common. Each individual can release their public keys and other individuals can detect if their sets have at least ‘t’ elements in common by attempting to decrypt the public key using their private key.

In this work similar to previous work (He et al., 2013), we use the fuzzy extractor to compute the symmetric set difference as a black box. Our goal is to encode the two haplotypes (diploid genome) for each individual to a set such that the symmetric set difference between individuals corresponds to the genetic similarity between the two individuals. In the previous method (He et al., 2013), only the common variants are used and assumed the list of variants between all the individuals are the same, as a result we convert the haplotypes to a set by considering non-overlapping segments. Thus, the symmetric set difference between the generated sets can approximate the hamming distance between their haplotypes. However, in our work we want to utilize the rare variants and relax the assumption that all individuals have access to the list of all the variants between all the individuals. In this work each haplotype is compared against the reference genome and the positions where they differ are marked as ‘1’ and the rest are marked as ‘0’. Thus, individuals that are related have more positions in the haplotype marked similarly as compared to the unrelated individuals. Using the encoded genome we generate ‘sketch’ that contains private information and is used as the private key. From the sketch we generate the ‘secure sketch’ and use it as the public key. In order for two individuals ‘A’ and ‘B’ to detect if they are related or not, individual ‘A’ compares its private sketch with the secure sketch obtained from individual ‘B’. If the two individuals are related the ‘fuzzy’ encryption method terminates successfully, if not the program fails.

We need to show our method is secure as each individual release a public key that is generated from each genome that contains private data. We need to show the amount of information obtained from public key is small relative to the total amount of data in each genome. We use entropy to measure the amount of information. Entropy is a known quantity to measure the amount of information in a data and entropy is an additive quantity. Thus, in order to show our method is secure we have to show the entropy in the human genome is much larger than the entropy in the public key (sketch). The entropy in ‘fuzzy’ encryption is bounded by t²/s where ‘t’ is the number of elements that are in common between the sets and s is the number of elements in each set. Intuitively, this value corresponds to the strength of an encryption. If there are 100 bits of entropy remaining, a brute force approach to identify the set would require the same effort to crack 100-bit encryption. As long as this number is 4100 bits, the protocol is relatively secure.

2.2 Estimating Genetic Relatives by Comparing Sets

There exist a series of methods to detect the relatedness among different individuals and even build the family tree using the Identity by descent (IBD) (Li et al., 2010; Stevens et al., 2011; Wang, 2011). In this section we describe a simple method to approximate the relatedness using the haplotype data which can be used to build a secure protocol.

We assume that we have N individuals and we have access to each individual's variants and the reference genome. In our method we only consider single-base variants which include both common and rare variants. Furthermore, we assume we have access to the phased haplotypes of each individual, in the case we have unphased haplotypes, we can phase them by using the existing methods (Browning and Browning, 2007; Li, Y. et al., 2010; Scheet and Stephens, 2006; Stephens and Scheet, 2010), we phased the individuals using a reference dataset of individuals which did not contain any individuals that are related to the ones we are phasing. We convert the two haplotypes for each individual to a single set such that the set comparison between the two individuals' haplotypes can estimate the genetic relatedness. In our method, unlike the previous method, the list of all the variants is not the same between all the individuals. Thus, we need to convert each individual's haplotypes to a binary string such that the hamming distance between the two strings estimates the similarity between the two individuals. Furthermore, the variants that occur in the same positions in the haplotype should be compared against each other. Thus, we use the reference genome to align the variants such the same variants are compared. We convert each individual genome (donor) to binary genome by comparing each donor genome to the reference genome, we convert each position to ‘0’ when there exists no variants between the donor and the reference genome and otherwise ‘1’. We partition each binary genome to non-overlapping segments of 30 000 bp. We generate a set for each individual such that each element of the set contains the segment data (string of length 30 000 which represents the binary genome of that segment) and the segment position. We compute the summation of the binary value of the segment position and the segment data and store the computed value in a set. In order to compute the summation we used the arithmetic addition operation for binary numbers. More formally, let Hᵢ indicates the i-th individual binary haplotypes where Hᵢ={Hᵢ¹, Hᵢ²} such that Hᵢ¹ and Hᵢ² represent the first and second haplotypes, respectively for i-th individual. In our model we consider two haplotypes for each individual as we assume we are dealing with diploid genomes (two copies of each chromosome). Moreover, Hᵢⱼ^{{1,\check{2}}}ε{0, 1{circumflex over (})}^{30 000} represent the i-th segment of the i-th individual's binary haplotype. We use Sᵢ to indicate the set for i-th individual and sᵢⱼ to indicate the j-th element of the set Sᵢ representing the j-th segment of genome.

$${s}_{ij}^{\{ 1 , 2 \}} = {H}_{ij}^{\{ 1 , 2 \}} + B ( j )$$

$${S}_{i}^{\{ 1 , 2 \}} = \{ {s}_{ij}^{\{ 1 , 2 \}} : ∀ j ∈ [ 1 … \frac{M}{30 , 000} ] \}$$

$${S}_{i} = {S}_{i}^{1} ⋃ {S}_{i}^{2}$$

where B\check{o}: [symbol] denotes the binary representation of an integer number and M denotes total number of base pair in each genome, in the case of human genome M=3 billion.

If the distance score between two individuals is 5‘t’ we consider them as related individuals and if the distance score is 4‘t’ we consider them as unrelated individuals. We assume the value of ‘t’ is computed using a training set where the true relationship between each pair of individuals is known.

In order to compute the number of matched segments between two individuals, we count the number of shared haplotypes for each segment between the two individuals. There exist three possible values for each segment: zero, one and two. Zero indicates both haplotypes in that segment are different between the two individuals, two indicates both haplotypes in that segment are the same between the two individuals and one indicates only one of the haplotypes is the same between the two individuals.

2.3 Protecting Privacy During Identification of Relatives

In order for individuals to securely compute the symmetric difference between their genomic sets, we define a sketch where we hash the value of each element in the genomic sets (Sᵢ). Let Kᵢ indicates the sketch of i-th individual and kᵢⱼ indicates the j-th element of the Kᵢ that is obtained by hashing the j-th element of the i-th individual genome set.

kᵢⱼ=h₂₄(sᵢⱼ+r)

where r is a random binary number of size 100 that is referred to as the salt, and h₂₄\check{o}: [symbol] is a collision-resistance hash function that returns the first 24 bits. One of the main properties of the elements in the secure set is that the similarity between two chunks is preserved. If two segments differ in one base pair their corresponding elements in the secure set differs due to the hash function.

Collision-resistance hash function has two main properties: first, collision-resistance hash function is one-way function. Second, finding distinct values which have the same hashed value is hard. We consider function ƒ to be a one way function such that given x computing ƒ(x) is easy. However, given the ƒ(x) computing the x is hard. It is worth mentioning two segments obtained from the same genomic position in the genome for two different individuals that differ in one base pair have a different sketch element. Thus, reverse engineering the genome given the secure set is extremely hard based on the hardness of inverting one way functions.

However, using the sketch for identification leaks information. We can compare the sketch of other individuals with our own sketch to detect which genome segments are similar. Thus, this results in the leak of information. We use the sketch as the private key and use the improved version of the Juels-Sudan construction (Dodis et al., 2008; Ishai et al., 2011) that uses list decoding, followed by a hash check to generate a secure sketch that is used as public key for individuals.

Using the above encoding, each individual is represented by a set containing 24-bit elements. Individual are related if they share at least ‘t’ of their elements. We can then use the secure set comparison from Section 2.1 to allow individuals to identify their relatives without requiring them to release their genomes.

The amount of entropy in ‘fuzzy’ encryption is bounded by t²/s where ‘t’ is the number of elements that are in common between the sets and s is the number of chunks. In the case of human s=3 000 000 000/30 000=100 000: Although computing the exact entropy of the human genome needs enormous number of individuals, He et al. (2013) show that the approximate amount of entropy in the human genome is much higher than t²/s. More detail is provided in Appendix A below.

2.4 Haplotype Encoding Independent of Genome Builds

The encoding mentioned in Section 2.2 depends on the genome build that is used to call variants. Thus, individuals using different genome builds are unable to compare their sets. In this section we propose a new encoding which makes the encoding independent from the genome build which is used to call the variants. Our encoding is based on the observation that variant positions are typically identifiable using the 500-bp flanking sequence and the number of variants which differ in flanking sequence between different builds is extremely low.

In this encoding each segment is of size 30 000 bp and each segment starts from a known common SNP in the dbSNP (http://www.ncbi.nlm.nih.gov/SNP/). Then, for each variant in the segment we consider the flanking sequence of length 500 bp around the variant. Virtually all common SNPs have been identified in the HapMap and 1000 G projects. We concatenate all the flanking sequences around each variant in a segment to represent the segment uniquely. Then, the collision resistance hash function is applied as described above to generate elements of the set.

2.5 Generating Simulated Data

In order for us to evaluate our method we must generate realistic simulations. We generate simulation by randomly mating individuals and generating a pedigree using a recombination rate of 10⁻⁷.

Since sequence errors and phasing errors affect the amount of matching in real data, for our simulations to be valid, we must use similar error rates. We utilize our real data to estimate the effect of these errors on matching in order to guide our simulations as follows. We first generate simulations without any error rates and compute the amount of matching for siblings unrelated individuals in real data compared to our simulated data. We then increase the error rate until the amounts of sharing are comparable and then utilize these parameters in our simulations.

Results

3.1 Simulated Data

In order to assess the performance of our method, we generated simulated data for different levels of relatedness using the 1000 genomes data. We used the LWK population which consists of 116 individuals. Among these 116 individuals 19 individuals have cryptic relationships that are removed from our data-generating process, and we used the remaining individuals as the founder individuals. In the first step, we used the founder individuals to generate offspring by randomly mating the individuals. Moreover, for simplicity we assume there exist no polygamy in the simulated data, thus each individual is mated with only one individual. In the next step, we use the generated offsprings to generate offsprings of the next generation by pairing together unrelated individuals from the current generation. We continue to generate new offsprings until we have sufficient number of distant relatives. In our case, we generated 10 generations from the founder individuals. Using this data we can check different levels of relatedness such as sibling, first-degree cousins, and second-degree cousins and up to sixth-degree cousins. We utilized a recombination rate of 10⁻⁷. We utilized a sequencing-error and phasing-error rate which is consistent with what we observe as the effect of errors on the amount of matching compared to what is expected in real data as we describe in Section 2.

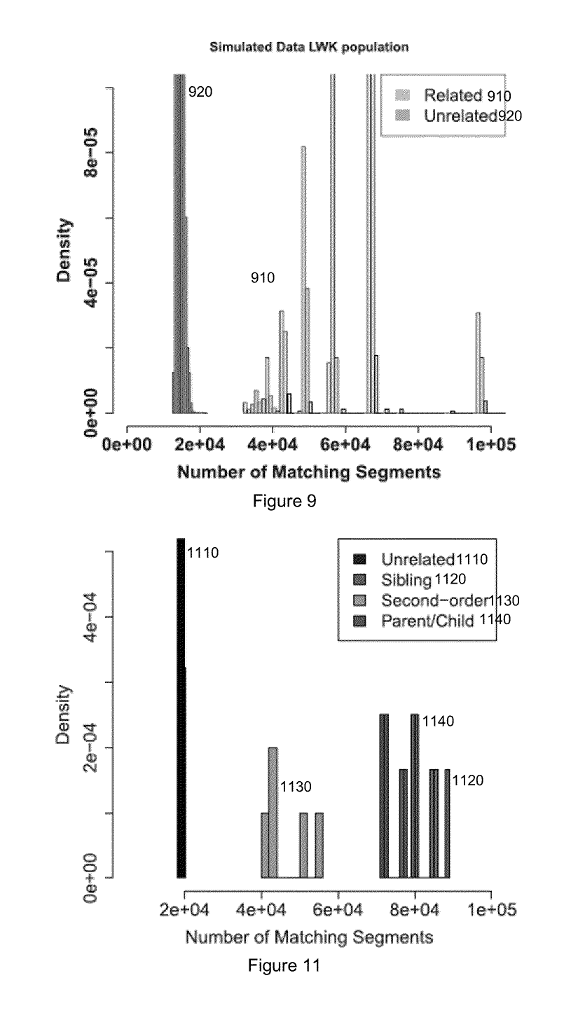

We compute the similarity score for each pair of individuals using our encoding. We show there exists a separation between the related and unrelated pairs of individuals which is shown in FIG. 9. We set the cut-off to 25 390 segments to separate the related individuals from unrelated individuals. In Appendix A we describe a principle way to select the cut-off.

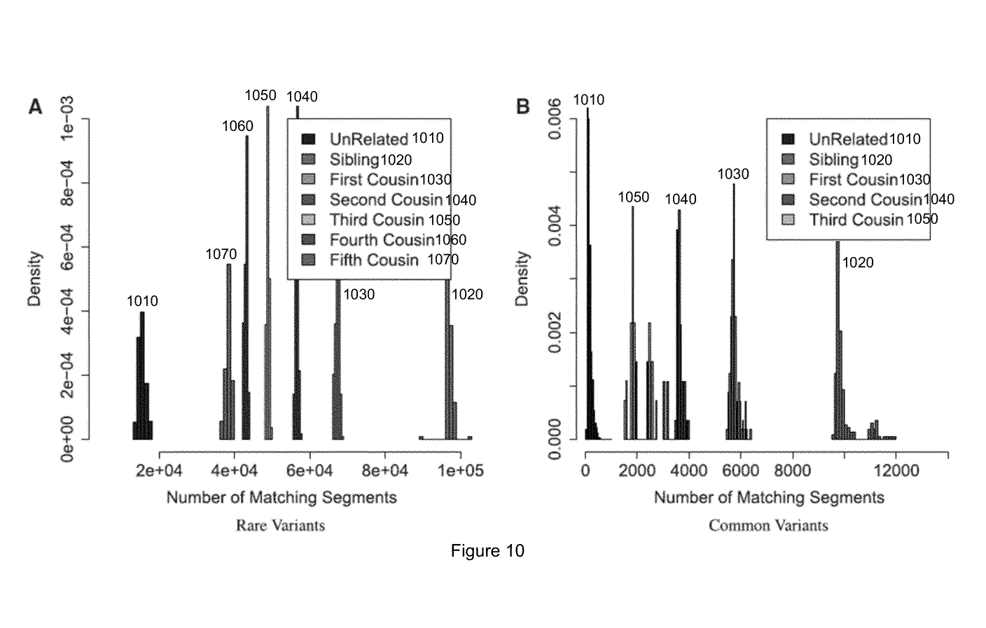

FIG. 10A indicates the histogram of similarity scores for different individuals. All pairs of individuals that have the same relationship are shown with the same color in the histogram. There exist a separation between the number of segments shared between related individuals compared to unrelated individuals, we set the cut-off to 25 390 segments to separate the related individuals from unrelated individuals. This result indicates that we can easily distinguish up to fifth-degree cousins using the rare variants. We note that in a previous approach, He et al. (2013) were able to distinguish only up to third-degree cousins which only utilize the common variants. The result of common variants is shown in FIG. 10B.

We run our method to generate the secure sketch (public key) for each simulated individual and then each individual uses the secure sketch of another individuals and compare to its own sketch (private key). As expected, for each pair of individuals that are related, the program terminates successfully. However, for unrelated pairs of individuals the program fails.

We use another population from the 1000 genomes to generate simulated data using the same process to make sure our results are not specific to only one population. We use the Mexican Ancestry in Los Angeles, Calif. (MXL) population. The MXL consist of 69 individuals where nine individuals have cryptic relationships. We removed the cryptic-related individuals so that the founders are unrelated. We observe there exists a separation between the related and unrelated using our method of comparing sets. We can detect up to fifth-degree cousins using our method. The results are similar to the LWK population and for the sake of space we did not show the results.

3.2 Real Data

In order to assess the results of our method we used the 1000 genomes data. Although the 1000 genomes data consist of unrelated individuals, there exists three populations that contain cryptic (not known before sequencing) relationships. These three populations are African Ancestry in Southwest (ASW), and LWK. We used the final phase of data. The ASW population consists of 66 individuals where 10 individuals have cryptic relationships. The LWK population consists of 116 individuals where 19 individuals have cryptic relationships. The cryptic relationships in this data are parent-child, sibling or second-order relationships.

In order to detect if two individuals are related or not there exist series of methods, the standard method is KING method (Manichaikul et al., 2010). In this work we use a simpler idea which can be used to build a secure protocol. We divide the genome to segments of length 30 000 bits. Then, for each pair of individuals we count the number of segments which are identical and then use a threshold to distinguish between related and unrelated individuals. As shown in FIG. 11 there exists a clear separation between the related and unrelated individuals based on the number of matched segments. Thus, the threshold of 25 390 number of segments can discriminate the related and unrelated individuals.

We run our method to generate the secure sketch (public key) for each individual in the 1000 genomes data. Then, each individual uses the secure sketches of other individuals and compare it with their own sketch (private key). As expected, for each pair of individuals that are related, the program terminates successfully. However, for unrelated pairs of individuals the program fails.

In order to check if the new encoding mention in Section 2.4 works, we used the known list of SNPs from Hg18 and Hg19 obtained from the HapMap project. For each SNP we consider 500-bp sequence around the SNP in both builds of Hg18 and Hg19. Then, we used the SSHA-256 to hash each string (1000 bp) and compared the hash value for the same SNPs in the two different builds. In our experiment we observed only 0.002 fraction of the SNPs will not have the same hash value. Meaning only 0.002 of SNPs are not mapped to the right SNP position when two different genome builds are used. As a result, the majority of SNPs are mapped to the same flanking sequence when moving from Hg19 to Hg18. Thus, the encoding which utilizes the flanking sequence can easily use a different genome build to generate keys to be compared with the other individual's public key that was generated using a different genome build.

Discussion

Sequencing technologies have made personal genomics possible and many companies are providing information about ancestry and health of individuals by utilizing genetic data. However, to obtain these information, each individual has to share their genomic data. The sharing of genomic data raises privacy issues.

One solution to the privacy issue is to use a trusted third party for detecting relatedness, however, individuals may not feel comfortable to share their genetic data with a trusted party for detecting related individuals. In this disclosure, we demonstrate detecting the relatedness between two individuals where both individuals have access to their genetic data and no third party is needed.

Recently, He et al. (2013) have proposed a secure method for detecting the genetic relatives using genotype data. This method uses the ‘fuzzy’ encryption. A limitation of He et al. (2013) is that only previously known variants which are common can be used in the method. Unfortunately, common variants are not as nearly as informative for identifying relatives as rare variants which are typically shared with only close family members.

In this work, we provide a secure method for individuals to detect the genetic relatives from sequencing data without exposing any information about their genomes that utilizes both common and rare variants and through simulated data, we demonstrate, we can detect up to fifth-degree cousins. We also show in two populations from the 1000 genomes data that contains cryptic relationships, our method can detect these individuals. Our method also utilized an encoding that allows us to compare individuals who utilized different genome builds for calling their variants. Thus, genomes encoded using today's genome build can be used to detect relatives called using future builds.

The input to our method is the phased haplotypes, in the case we have unpashed data, we phase our data using an existing method (Browning and Browning, 2007; Li, Y. et al., 2010; Scheet and Stephens, 2006); Stephens and Scheet, 2010). We phased the individuals using a reference dataset of individuals which did not contain any individuals that are related to the ones we are phasing. We note that sequencing errors and phasing errors decrease the amount of segment matches between related individuals because an error in a segment that matches will appear as a segment that does not match. Our experiments over real data already implicitly take into account the sequencing and phasing errors because any errors decrease our observed amount of similarity among related pairs. As sequencing technologies mature and the error rates decrease, we expect that the number of matches between related individuals will increase accordingly.

### REFERENCES

Blahut, R. E. (1983) Theory and Practice of Error-correcting Codes. Addison-Wesley, Reading, Mass.
Browning, S. R. and Browning, B. L. (2007) Rapid and accurate haplotype phasing and missing-data inference for whole-genome association studies by use of localized haplotype clustering. Am. J. Hum. Genet., 81, 10841097.
Genomes Project Consortium. (2010) A map of human genome variation from population-scale sequencing. Nature, 467, 1061-1073.
Genomes Project Consortium. (2012) An integrated map of genetic variation from 1,092 human genomes. Nature, 491, 56-65.
Dodis, Y. et al. (2008) Fuzzy extractors: How to generate strong keys from biometrics and other noisy data. SIAM J. Comput., 38, 97-139.
Guruswami, V. and Sudan, M. (1998) Improved decoding of reed-solomon and algebraic-geometric codes. In: Foundations of Computer Science, 1998. Proceedings of 39th Annual Symposium on, Palo Alto, Calif. IEEE, pp. 28-37.
He, D. et al. (2013) Indetifying genetics relatives without compromising privacy. Genome Res., 24, 664-672.
Homer, N. et al. (2008) Resolving individuals contributing trace amounts of DNA to highly complex mixtures using high-density SNP genotyping microarrays. PLoS Genet., 4, e1000167.
Ishai, Y. et al. (2011) Efficient non-interactive secure computation. SIAM J. Comput., 38, 97-139.
Li, X. et al. (2010) Efficient identification of identical-by-descent status in pedigrees with many untyped individuals. Bioinformatics, 26, i191-i198.
Li, Y. et al. (2010) Mach: using sequence and genotype data to estimate haplotypes and unobserved genotypes. Genet. Epidemiol., 34, 816834.
Manichaikul, A. et al. (2010) Robust relationship inference in genome-wide association studies. Bioinformatics, 26, 2867-2873.
Sankararaman, S. et al. (2009) Genomic privacy and limits of individual detection in a pool. Nat. Genet., 41, 965-967.
Scheet, P. and Stephens, M. (2006) A fast and flexible statistical model for large-scale population genotype data: applications to inferring missing genotypes and haplotypic phase. Am. J. Hum. Genet., 78, 629644.
Stephens, M. and Scheet, P. (2010) Accounting for decay of linkage disequilibrium in haplotype inference and missing-data imputation. Am. J. Hum. Genet., 76, 449462.
Stevens, E. L. et al. (2011) Inference of relationships in population data using identity-by-descent and identity-by-state. PLos Genet., 7, e1002287.
Van Lint, J. H. (1982) Introduction to Coding Theory. Vol. 86, Springer-Verlag Berlin Heidelberg
Wang, J. (2011) Unbiased relatedness estimation in structured populations. Genetics, 187, 887-901.

### APPENDIX

### A1. Separation Cut-Off Between Related and Unrelated Individuals

In this section we describe a principled way to select a cut-off to separate the related from unrelated individuals. Using real data we observe the number of segments shared between unrelated individuals follows a normal distribution N\check{o}μ; a² [symbol] where the mean of the distribution is 19 325 and the standard deviation is 1080. Supplementary FIG. 12 illustrates the QQplot of the number of matched segments between each pair of unrelated individuals in LWK population. Unfortunately, the real data lack sufficient number of related individuals to observe if the number of segments between related individuals follows a normal distribution or not.

Given that the number of shared segments for unrelated individuals Mows a normal distribution \check{o}X″″N\check{o}μ; a² [symbol] [symbol] ; we select a cut-off value of c such that the probability of observing a value 4c for the number of matched segment in unrelated individuals is extremely small such as 1e−8.

P\check{o}X□c [symbol] :::1e−8

Thus, in our real data we set the cut-off to 25 390 (c=25 390).

### A2. Improved Juels-Sudan Construction

In more detail, the idea of a secure sketch is based on the notion of an error correcting code (ECC) [Blahut (1983), Van Lint (1982) provide good introductory treatment of the theory or error correction]. An ECC is used to provide a reliable means of communication over noisy channels. Here, we provide a very brief and simplified overview of ECC that is sufficient for our purposes. For positive integers n, k, d, an (n, k, d) ECC is a k-dimensional subspace of an n-dimensional vector space. Each element of the k-dimensional subspace is called a codeword. The parameter d specifies the distance of the code, which means that the Hamming distance (the Hamming distance between two n-dimensional vectors is the number of co-ordinates where they differ) between any two code words is at least d. Thus intuitively, the distance of a code is a measure of how ‘spread-out’ the code words are in the n-dimensional space. Finally, the ECC comes with a mechanism to ‘correct small errors’. This means that given a codeword v, if we change a small number of coordinates of v to get a vector w, then there exists an algorithm that on input w, outputs the ‘correct’ codeword v. Formally, an ECC comes with an efficient Decoding Algorithm, which works as follows: given any n-dimensional vector w as input, if there exists a codeword within distance d/2 of w, then the decoding algorithm outputs that vector, otherwise, it outputs an error message specifying that decoding failed. Note that as the distance of the code is d, there can be at most a single codeword within a distance d/2 of any vector w. This is called unique decoding.

The Juels-Sudan construction that we use from Dodis et al. (2008) is based on a particular kind of ECC, called the Reed-Solomon code. We first give a brief overview of the Reed-Solomon construction, and then describe the Juels-Sudan construction, An (n, k, d) Reed-Solomon code is a particular kind of ECC that is defined as follows: fix a finite field F (in our case, the field P will be the Galois field GF\check{o}2²⁴ [symbol] [symbol] ; and consider the n-dimensional vector space Fⁿ. To define the k-dimensional subspace of code words, we begin by fixing a sequence of n points \check{o}a₁; . . . ; aₙ [symbol] ; where each aᵢ is an element of F. The subspace of code words is obtained by evaluating all the degree k−1 polynomials (over F) on the points \check{o}a₁; . . . ; aₙ [symbol] ; i.e. let ƒ\check{o} be a degree k−1 polynomial whose coefficients are elements of F. Then the corresponding code word is \check{o}ƒ\check{o}a₁ [symbol] ; . . . ; ƒ\check{o}aₙ [symbol] [symbol] : The code word subspace consists of the evaluations of all degree k−1 polynomials. It follows from elementary algebra that the distance of the Reed-Solomon code is d=n−k+1: The details of the decoding algorithm can be found in Blahut (1983), Van Lint (1982).

Now we are ready to describe the improved Juels-Sudan construction from Dodis et al. (2008). Recall that the genome is represented as a set of 24-bit strings, which we take to be elements from the field GF\check{o}2²⁴ [symbol] : Let s₁=fw₁; . . . ; wₙg be such a set. Our task is to convert the genome sketch s₁ to a ‘secure sketch’ ss₁, which satisfies two properties: (i) the secure sketch should not reveal too much information about s₁, and (ii) given the genome sketch s₂=fv₁; . . . ; vₙg of another individual and the secure sketch ss₁ of the first individual we should be able to determine if the two individuals are related or not. The Juels-Sudan algorithm uses algebraic techniques to achieve this.

One of the main ideas of the Juels-Sudan construction is to represent the genome sketch as a polynomial. In particular, we first construct a polynomial p(x) whose roots are the wᵢs; that is p(x)=Πᵢ₌₁ⁿ(x−^{x}wᵢ{hacek over ())}. Note that anyone who knows p(x) can obtain the entire genome sketch by simply finding the roots of p(x). Thus, in particular, we cannot use p(x) itself as the secure sketch (as it reveals too much information about the genome). Instead, the idea is to reveal only a small part of the polynomial p(x), and reconstruct the rest using error correction. This is done as follows: p(x) is split into two polynomials p_{high}\check{o}x [symbol] and p_{low}\check{o}x [symbol] : Polynomial p_{high}\check{o}x [symbol] is a degree-n polynomial that matches p(x) in the ′ highest coefficients, and all the other coefficients are 0 (here, the parameter ′ will be determined later). The polynomial p_{low}\check{o}x [symbol] is a degree-n−′ polynomial that matches with p(x) in the n−′ smallest coefficients. Thus, p\check{o}x [symbol] =p_{high}\check{o}x [symbol] +p_{low}\check{o}x [symbol] : Only the polynomial p_{high}\check{o}x [symbol] is released in public. To complete the scheme, we have to show two things: (i) revealing p_{high}\check{o}x [symbol] does not reveal too much information about the genome sketch, and (ii) given p_{high}\check{o}x [symbol] ; and the genome sketch of another individual, we can find out if there is a match or not.

We first describe how matches are determined. Let f v₁; . . . ; vₙ g be the genome sketch of another individual. Note that if we can reconstruct the polynomial p(x), then it is easy to check if there is a match or not (as p(x) contains all information about the sketch f w₁; . . . ; wₙ g [symbol] : As p_{high}\check{o}x [symbol] is publicly available, our task is to reconstruct p_{low}\check{o}x [symbol] : First, note the following mathematical fact: as wᵢ is a root of p(x), we have, p\check{o}wᵢ [symbol] =0; which implies that p_{high}\check{o}wᵢ [symbol] +p_{low}\check{o}wᵢ [symbol] =0 or p_{low}\check{o}wᵢ [symbol] =−p_{high}\check{o}wᵢ [symbol] : This implies that even though we do not have p_{low}\check{o}x [symbol] ; we can evaluate it on wᵢ given p_{high}\check{o}x [symbol] ; which is publicly available. Further, if we can evaluate p_{low}\check{o}x [symbol] on large enough number of points, then we can reconstruct p_{low} \check{o}x [symbol] using elementary algebra (by a process called polynomial interpolation). However, we do not have access to the wᵢs, but only to vᵢs. But if the individuals are related, then the genome sketches of the individuals are close together, which means most of the wᵢs are the same as vᵢs. Thus, if we evaluate p_{high}\check{o}x [symbol] on the vᵢs, we obtain a ‘noisy’ version of the evaluations of p_{low}\check{o}x [symbol] : And this can now be corrected using error correction. In particular, we construct the n-dimensional vector \check{o}p_{low}\check{o}v₁ [symbol] ; . . . ; p_{high}\check{o}vₙ [symbol] [symbol] ; and run the decoding algorithm of the Reed-Solomon code on it. If the two genome sequences are close by, then this algorithm outputs closest code word, which is \check{o}p_{high}\check{o}w₁ [symbol] ; . . . ; p_{high}\check{o}wₙ [symbol] [symbol] ; from which p_{low}\check{o}x [symbol] can be reconstructed.

Now we come to the first point above, namely that revealing p_{high}\check{o}x [symbol] does not reveal too much information about the genome. Clearly, the amount of information released depends on the value of ′; the smaller the value of ′, the smaller the amount of information released. On the other hand, we cannot make ′ too small, as then we will not have enough information to decode (note that we are trying to reconstruct an n−′-degree polynomial from n noisy points). Let t be the threshold for matching, i.e. if two individuals are related, then there genome sketches have at least t points in common. Then, to minimize the value of ′, we need to find the largest degree of the polynomial p_{low}\check{o}x [symbol] that can be correctly decoded given n points, with threshold t. For the Reed-Solomon code with unique decoding, this turns out to be t, and thus the remaining entropy is equivalent to t field elements.

Unfortunately, the way we have described the Juels-Sudan scheme above does not work for our application. The reason is that unique decoding of Reed-Solomon requires that the agreement be very high, as compared to the size of the genome sketch. However, in our application, even if the individuals are related, the agreement can be very small. Thus, we move to a more sophisticated error correction scheme called ‘list-decoding’ for Reed-Solomon codes. The main advantage of list-decoding over unique decoding is that it can tolerate very small agreement thresholds also. The scheme remains essentially as we have described so far, except that in the reconstruction step, instead of using unique decoding to reconstruct p_{low}\check{o}x [symbol] ; we use the list-decoding algorithm from Guruswami and Sudan (1998). The remaining entropy in this case turns out to be t²=s field elements. In the case of human s==3 000 000 000/30 000=100 000: Although computing the exact entropy of the human genome needs enormous number of individuals, He et al. (2013) show that the approximate amount of entropy in the human genome is much higher than t²/s.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

In alternate embodiments, the invention is implemented in computer hardware, firmware, software, and/or combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

What is claimed is:

1. A method for determining whether a first genome is related to a second genome, comprising:
accessing a publicly available secure genome sketch of the first genome; and
comparing the secure genome sketch of the first genome to a privately held genome sketch of the second genome.

2. A method for making genome data publicly available while maintaining privacy, comprising:
generating secure genome sketches of genomes; and
making the secure genome sketches publicly available.

3. A method for identifying relatives of a first genome from among a pool of second genomes, comprising:
accessing publicly available secure genome sketches of the second genomes;
comparing the secure genome sketches of the second genome to a privately held genome sketch of the first genome; and
determining a degree of relatedness based on said comparison.
